(19) United States
(12) Patent Application Publication
(10) Pub. No.: US 2025/0373196 A1
(43) Pub. Date: Dec. 4, 2025

(54) SHEET METAL SOLAR MODULE FRAMES

(71) Applicant: Nextracker LLC, Fremont, CA (US)

(72) Inventors: Lincoln Duca Silva, Sorocaba - SP (BR); Matheus Martins Lopes Machado, Sorocaba - SP (BR); Paulo de Oliveira Weinhardt, Sorocaba - SP (BR)

(21) Appl. No.: 19/214,680

(22) Filed: May 21, 2025

Related U.S. Application Data
(60) Provisional application No. 63/654,364, filed on May 31, 2024.

(51) Int. Cl. H02S 20/32

(52) U.S. Cl. CPC H02S 20/32

(57) ABSTRACT

A solar module frame assembly includes first and longitudinal frame portions and first and second lateral frame portions. The first and second longitudinal frame portions can include an intermediate wall, a photovoltaic receptacle at one end portion of the intermediate wall, and a lower wall potion at another, opposite end portion of the intermediate wall. The lower wall portion of each of the first and second longitudinal frame portions can include one or more connecting tabs. The first and second lateral frame portions can include a vertical or skewed intermediate wall, a photovoltaic receptacle at one end portion of the vertical or skewed intermediate wall, and a base at another, opposite end portion of the vertical or skewed intermediate wall. The vertical or skewed intermediate wall can include one or more connecting tabs that are configured to engage with corresponding aperture(s) at the adjacent first and second longitudinal frame portions.

### RELATED APPLICATION

This disclosure claims priority to U.S. Provisional Patent Application No. 63/654,364, filed May 31, 2024, the content of which is hereby incorporated by reference.

### TECHNICAL FIELD

This disclosure relates generally to device, system, and method embodiments of solar module frames as well as to device, system, and method embodiments for coupling one or more solar module frames to a support structure. Solar module frames and related coupling device, system, and method embodiments disclosed herein can be configured to facilitate more efficient and effective installation of one or more solar modules to a support structure, such as a torque tube of a solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application.

### SUMMARY

This disclosure in general describes device, system, and method embodiments of solar module frames as well as to device, system, and method embodiments for coupling one or more solar module frames to a support structure. Solar module frames and related coupling device, system, and method embodiments disclosed herein can be configured to facilitate more efficient and effective installation of one or more solar modules to a support structure. For example, solar module frames and/or coupling apparatus embodiments disclosed herein can be configured to facilitate more efficient and effective installation of one or more solar module frames to a torque tube of a solar tracker (e.g., a single-axis solar tracker). In some such examples, solar module frames and/or coupling device, system, and method embodiments disclosed herein can be configured to facilitate automated (e.g., autonomous, such as fully or partially robotic) installation of one or more solar modules to a torque tube using one or more solar module frames and/or coupling apparatus embodiments disclosed herein. In additional or alternative such examples, solar module frame coupling device, system, and method embodiments disclosed herein can be configured to reduce a number of fastening connection points needed between components to effectively couple a solar module frame to a torque tube and, thereby, can help to reduce costs associated with solar tracker installation.

One embodiment includes a solar frame coupling apparatus. This apparatus embodiment includes a first solar module frame assembly, a second solar module frame assembly, and a slide attachment rail. The first solar module frame assembly include a first longitudinal frame portion, a second longitudinal frame portion opposite the first longitudinal frame portion, a first lateral frame portion, and a second lateral frame portion opposite the second lateral frame portion. The first longitudinal frame portion of the first frame assembly includes one or more connecting tabs and one or more slots (e.g., at least two connecting tabs and at last two slots at a lower wall portion of the first longitudinal frame portion of the first frame assembly). The second solar module frame assembly include a first longitudinal frame portion, a second longitudinal frame portion opposite the first longitudinal frame portion, a first lateral frame portion, and a second lateral frame portion opposite the second lateral frame portion. The first longitudinal frame portion of the second frame assembly includes one or more connecting tabs and one or more slots (e.g., at least two connecting tabs and at last two slots at a lower wall portion of the first longitudinal frame portion of the second frame assembly). The slide attachment rail includes a frame connector. The frame connector at the slide attachment rail includes a first side that includes one or more connecting tabs and a second, opposite side that includes one or more connecting tabs. As the first frame assembly is moved along the first side of the frame connector at the slide attachment rail, the one or more connecting tabs at the first side of frame connector are configured to be brought into engagement with the one or more slots at the first longitudinal frame portion of the first frame assembly to cause the first frame assembly to engage at the slide attachment rail. When so engaged, the one or more connecting tabs (e.g., folded connecting tabs) at the first longitudinal frame portion of the first frame assembly can engage at opposite radial sides of the connector at the slide rail attachment. Similarly, as the second frame assembly is moved along the second side of the frame connector at the slide attachment rail, the one or more connecting tabs at the second side of the frame connector are configured to be brought into engagement with the one or more slots at the first longitudinal frame portion of the second frame assembly to cause the second frame assembly to engage at the slide attachment rail. When so engaged, the one or more connecting tabs (e.g., folded connecting tabs) at the first longitudinal frame portion of the second frame assembly can engage at opposite radial sides of the connector at the slide rail attachment.

Another embodiment includes a solar module frame assembly. This solar module frame assembly includes a first longitudinal frame portion, a second longitudinal frame portion opposite the first longitudinal frame portion, a first lateral frame portion, and a second lateral frame portion opposite the second lateral frame portion. The first and second longitudinal frame portions can include an intermediate wall, a photovoltaic receptacle at one end portion of the intermediate wall, and a lower wall potion at another, opposite end portion of the intermediate wall. The lower wall portion of each of the first and second longitudinal frame portions can include one or more connecting tabs. The first and second lateral frame portions can include a vertical or skewed intermediate wall, a photovoltaic receptacle at one end portion of the vertical or skewed intermediate wall, and a base at another, opposite end portion of the vertical or skewed intermediate wall. The vertical or skewed intermediate wall can include one or more connecting tabs. The connecting tabs at the vertical or skewed intermediate wall of the first and second lateral frame portions can be configured to engage with corresponding aperture(s) at the adjacent first and second longitudinal frame portions, and/or the connecting tabs at the intermediate wall of the first and second longitudinal frame portions can be configured to engage with corresponding aperture(s) at the adjacent first and second lateral frame portions.

In a further embodiment of this solar module frame assembly, the intermediate wall of each of the first and second longitudinal frame portions can extend at a skewed orientation such that a longitudinal axis of the intermediate wall intersects a longitudinal axis of the lower wall. For instance, when the intermediate wall at each of the first and second lateral frame portions is a skewed intermediate wall, the intermediate wall of each of the first and second longitudinal frame portions can extend at a skewed orientation.

Another embodiment includes a pin coupler. This pin coupler can have a pin body that includes a pin base and a pin shaft that extends out from the pin base. The pin shaft can include a recessed rail engagement region and a recessed frame engagement region. The recessed rail engagement region can be bounded at one side by the pin base and at another, opposite side by a first pin shoulder. The recessed frame engagement region can be spaced apart along the pin shaft from the recessed rail engagement region, and the recessed frame engagement region can be bounded at one side by a second protruded shoulder and at another, opposite side by a third protruded shoulder. The pin coupler can be configured to engage a rail component at the recessed rail engagement region and configured to engage one or more solar module frame assemblies (e.g., a pair of solar module frame assemblies) at the recessed frame engagement region to thereby secure such one or more solar module frame assemblies (e.g., a pair of solar module frame assemblies) to the rail via the pin coupler.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIG. 2 is a perspective view of an embodiment of a solar module frame assembly.

FIGS. 3A-3C illustrate embodiments of a lateral frame portion of the solar module frame assembly of FIG. 2. FIG. 3A is an elevational view of one embodiment of a lateral frame portion of the solar module frame assembly of FIG. 2. FIG. 3B is an elevational view of another embodiment of a lateral frame portion of the solar module frame assembly of FIG. 2. FIG. 3C is an elevational view of an additional embodiment of a lateral frame portion of the solar module frame assembly of FIG. 2.

FIGS. 4A-4B illustrate embodiments of a longitudinal frame portion of the solar module frame assembly of FIG. 2. FIG. 4A is an elevational view of one embodiment of a longitudinal frame portion of the solar module frame assembly of FIG. 2. FIG. 4B is an elevational view of another embodiment of a longitudinal frame portion of the solar module frame assembly of FIG. 2.

FIGS. 5A-5B illustrate one example for assembling together pairs of longitudinal frame portions and pairs of lateral frame portions to form the solar module frame assembly of FIG. 2. FIG. 5A is an exploded, perspective view of the solar module frame assembly of FIG. 2. FIG. 5B is a close-up perspective view of one embodiment of a connection joint between one longitudinal frame portion and one lateral frame portion.

FIGS. 6A-6B illustrate further embodiments of a longitudinal frame portion and/or lateral frame portion with one or more additional features. FIG. 6A is a perspective view of a portion of a longitudinal frame portion and/or lateral frame portion having one or more force dampening pins at a force dampening flange of the frame portion. FIG. 6B is a perspective view of a portion of a longitudinal frame portion and/or lateral frame portion having one or more connecting tabs for coupling the frame portion to a support structure, such as a rail (e.g., slide attachment rail).

FIGS. 7A-7F illustrate coupling solar module frame assemblies, such as a plurality of solar module frame assemblies of FIG. 2, to a slide attachment rail at a torque tube of a solar tracker. FIG. 7A is a perspective view showing an embodiment of slide attachment rails at the torque tube and exploded, plurality of solar module frame assemblies, such as of FIG. 2, to be coupled to the slide attachment rails at the torque tube. FIG. 7B shows a first elevational view of a pair of solar module frame assemblies, such as of FIG. 2, exploded relative to the slide attachment rail at the torque tube, and FIG. 7C shows the same but at a second side elevational view rotated ninety degrees from the first side elevational view of FIG. 7B (such that in FIG. 7C only one of the pair of solar module frame assemblies is seen). FIGS. 7D-7F show the plurality of solar module frame assemblies of FIG. 7A coupled to the slide attachment rails at the torque tube, with FIG. 7D showing a perspective view of the plurality of solar module frame assemblies of FIG. 7A coupled to the slide attachment rails, FIG. 7E showing the first elevational view of FIG. 7B but with the pair of solar module frame assemblies now coupled to the slide attachment rail, and FIG. 7F showing the second side elevational view of FIG. 7C but with the solar module frame assemblies now coupled to the slide attachment rail.

FIGS. 8A-8C illustrate one embodiment of coupling slide assembly orientation features that can be included at one or more frame portions of the solar module frame assembly and/or the slide attachment rail. FIG. 8A is an elevational view of a frame portion (e.g., lateral frame portion and/or longitudinal frame portion) having rail slide flange orientation receptacles. FIGS. 8B and 8C show, respectively, a perspective view and an elevational view of the slide attachment rail with rail slide flanges.

FIGS. 9A-9B illustrate frame portion features for stacking a plurality of solar module frame assemblies, such as for transport. FIG. 9A is an exploded, perspective view showing a stacking axis between two solar module frame assemblies (e.g., two solar module frame assemblies of FIG. 2). FIG. 9B is an elevational view of a stack of a plurality of solar module frame assemblies (e.g., a stack of a plurality of solar module frame assemblies of FIG. 2).

FIGS. 10A-10C illustrate an embodiment of a solar module pin coupler. FIG. 10A is a perspective view of the embodiment of the solar module pin coupler. FIG. 10B shows an exploded, perspective view of a pair of solar module frame assemblies (e.g., of FIG. 2) along an coupling axis, and FIG. 10C shows the view of FIG. 10B with the pair of solar modules coupled to the rail, along the coupling axis, via the solar module pin coupler.

### DETAILED DESCRIPTION

The following detailed description is exemplary in nature. The following description provides some practical illustrations for implementing examples of the present invention. Those skilled in the art will recognize that many of the noted examples have a variety of suitable alternatives.

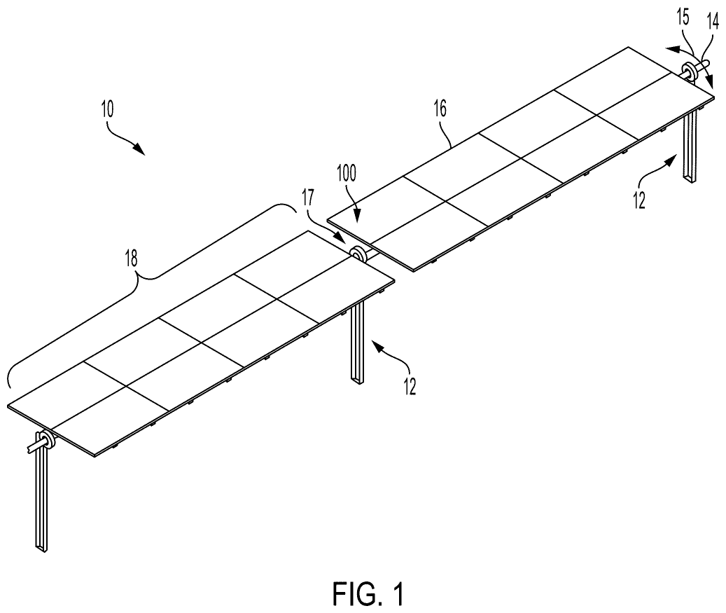

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells, such as a photovoltaic laminate with a plurality of photovoltaic cells) supported at the torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame assembly 100 that is coupled to the torque tube 14. As will be described herein, in some instances, the solar module frame assembly 100 can be directly coupled to the torque tube 14 and in other instances the solar module frame assembly 100 can be indirectly coupled to the torque tube 14 by coupling the solar module frame assembly 100 directly to a rail component (e.g., slide attachment rail) and coupling that rail to the torque tube 14. As will also be described herein, in various embodiments, adjacent pairs solar module frame assemblies 100 of adjacent pairs of solar modules 16 can be coupled together to the torque tube 14 (e.g., indirectly using a common rail component). The following disclosure will describe various solar module frame assembly embodiments as well as coupling assemblies and components that can be used, for instance, in a solar tracker to couple one or more solar modules to a torque tube of a solar tracker. Such embodiments disclosed herein can be useful in facilitating more labor-efficient solar module frame installation at a solar tracker apparatus and/or reduced material costs by reducing material and/or a number of fastening connection points associated with coupling a solar module frame assembly to the torque tube (e.g., indirectly via rail). For instance, embodiments disclosed herein can reduce a number of connection points, such as between a solar module frame assembly and a rail and/or between a rail (e.g., slide attachment rail) and a torque tube. These embodiments can thus be useful in increasing the cost efficiency associated with installing a solar tracker system in the field. For example, such embodiments disclosed herein can provide structures at solar module frame components and/or rail components that are conducive to robotic installation along a robotic work axis while also reducing a number of connection points.

Thus, solar module frame assemblies, coupling apparatuses, and the components thereof, can be configured to facilitate more efficient and effective coupling installation of one or more solar module frame assemblies to a support structure. For example, solar module frame assemblies and coupling apparatus embodiments disclosed herein can be configured to facilitate more efficient and effective installation of one or more solar module frames to a torque tube, such as in solar tracker applications, for instance, such as that shown at the example of FIG. 1. These solar module frame assemblies and coupling apparatus embodiments will be discussed as follows in conjunction with the accompanying drawing figures. The illustrated embodiments are examples of the inventive concepts disclosed herein and as such it should be noted that features of various illustrated solar module frame assemblies and coupling apparatus embodiments can be intermixed and combined for certain applications within the scope of this disclosure.

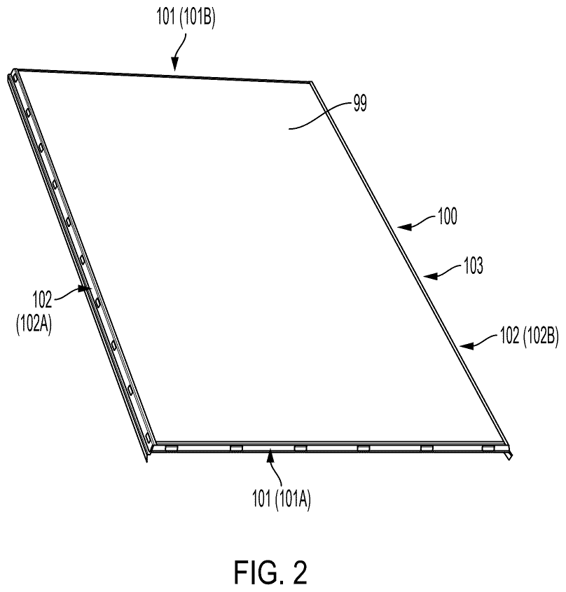

FIG. 2 illustrates a perspective view of an embodiment of a solar module frame assembly 100. Solar module frame assembly 100 can include one or more lateral frame portions 101 and one or more longitudinal frame portions 102. The one or more lateral frame portions 101 and one or more longitudinal frame portions 102 can be joined together to form solar module frame 103. Solar module frame 103 can bound and support a plurality of photovoltaic cells 99, such as bound and support a plurality of photovoltaic cells 99 at a laminate substate that is received at, and supported and bounded by, the solar module frame 103. Together, solar module frame 103 and photovoltaic cells 99 can form solar module 16.

More specifically, the illustrated embodiment of the frame assembly 100 includes a pair of lateral frame portions 101—first lateral frame portion 101A and second lateral frame portion 101B—and a pair of longitudinal frame portions 102—first longitudinal frame portion 102A and second longitudinal frame portion 102B. The first and second lateral frame portions 101A, 101B can be at opposite sides of the frame assembly 100, and the first and second longitudinal frame portions 102A, 102B can be at opposite sides of the frame assembly 100. As shown here, the first and second longitudinal frame portions 102A, 102B can be longer than the first and second lateral frame portions 101A, 101B such that the frame assembly 100 defines a rectangular shape with longitudinal sides longer than lateral sides.

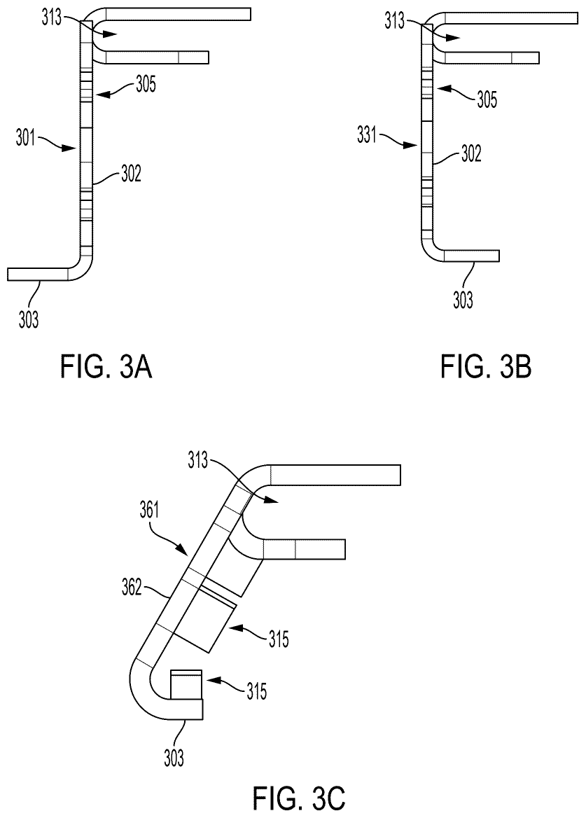

FIGS. 3A-3C illustrate embodiments of lateral frame portion 101 of the solar module frame assembly 100. FIG. 3A is an elevational view of one embodiment of a lateral frame portion 301 of the solar module frame assembly 100. FIG. 3B is an elevational view of another embodiment of a lateral frame portion 331 of the solar module frame assembly 100. FIG. 3C is an elevational view of an additional embodiment of a lateral frame portion 361 of the solar module frame assembly 100. For example, one or both of pair of lateral frame portions 101A, 101B of the frame assembly 100 can be the lateral frame portion 301, lateral frame portion 331, and/or the lateral frame portion 361.

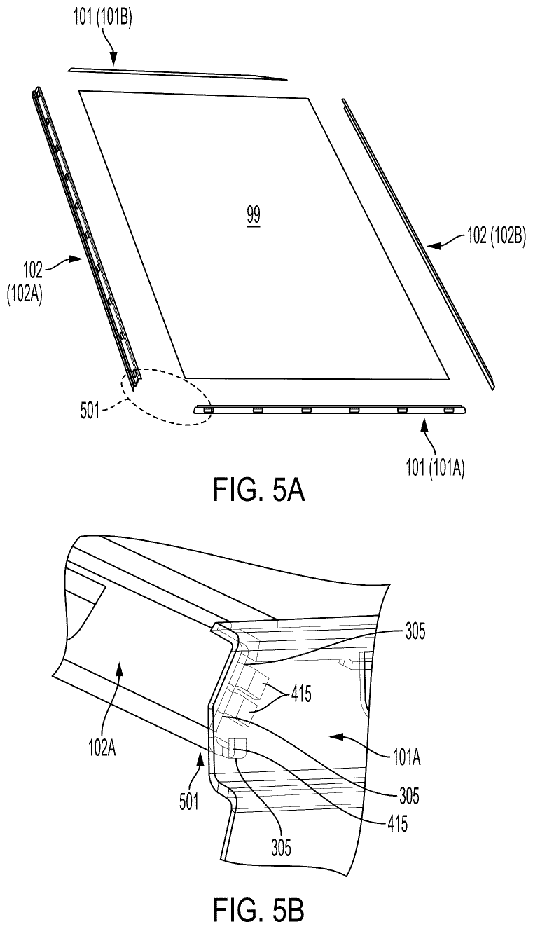

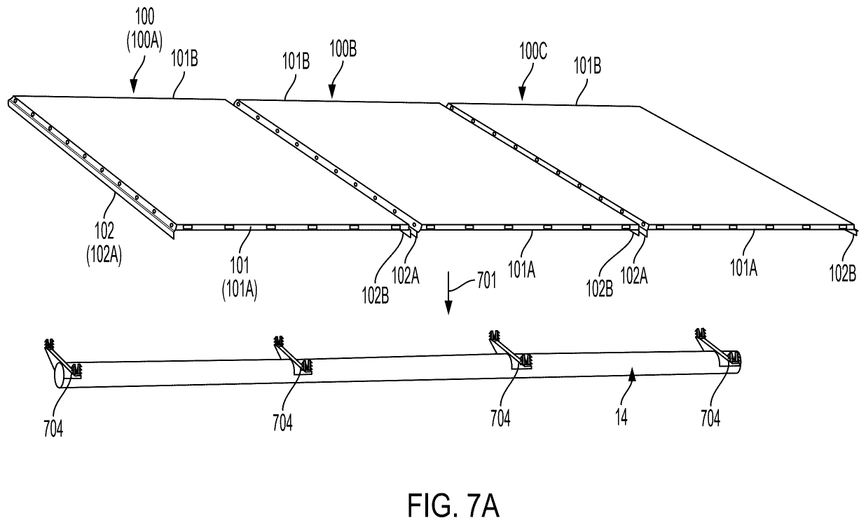

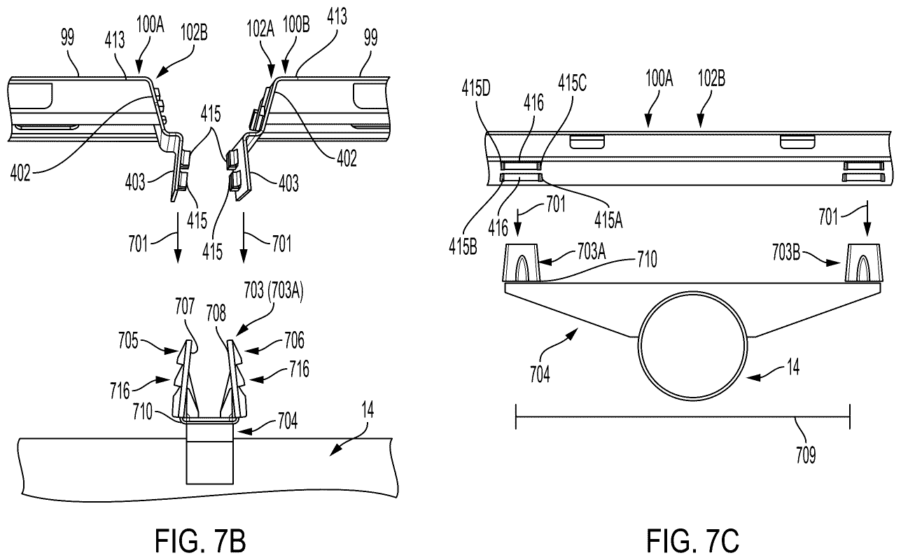

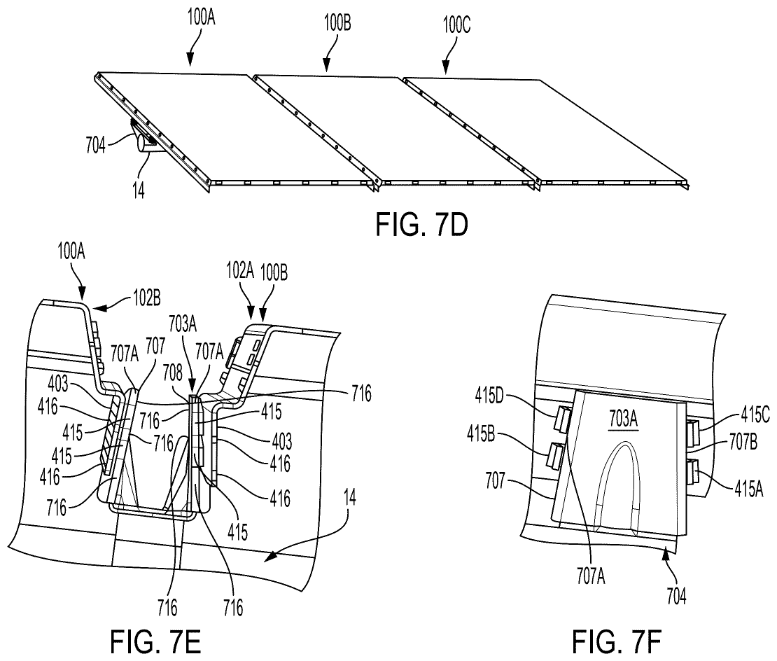

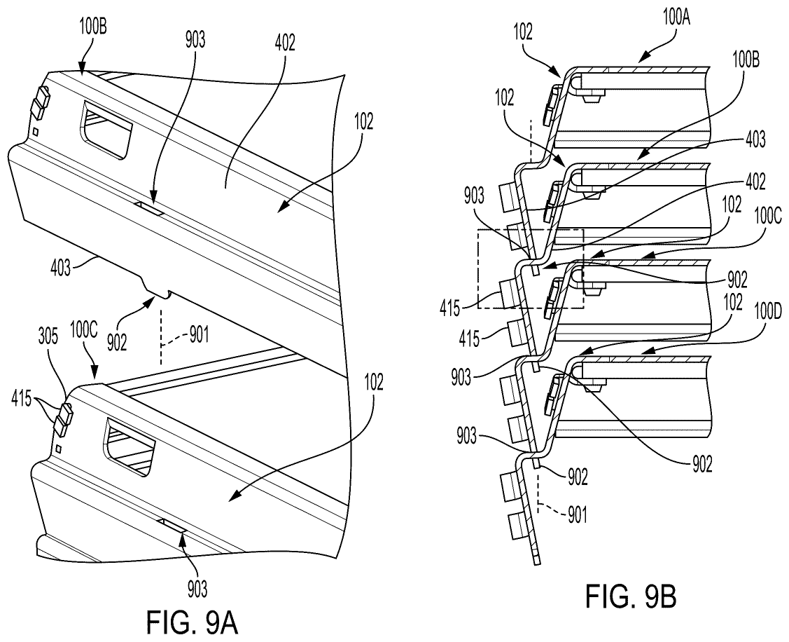

Referring to the embodiment shown at FIG. 3A, the lateral frame portion 301 can include photovoltaic receptacle 313, vertical wall 302, and base 303. Photovoltaic receptacle 313 can be configured to receive photovoltaic cells 99, such as configured to receive a photovoltaic laminate therein. Photovoltaic receptacle 313 can be at one end portion of the vertical wall 302 and the base 303 can be at another, opposite end portion of the vertical wall 302. The vertical wall 302 can include one or more connection apertures 305 that can be configured to form a connection with an adjacent component, for instance configured to receive a complementary connecting tab (e.g., of a longitudinal frame portion 102) to form a connection joint between adjacent frame portions (e.g., to form a connection joint between a lateral frame portion 101 and a longitudinal frame portion 102, such as seen at FIGS. 5B and 9A) and/or to receive a complementary connecting tab of a slide attachment rail (e.g., to form a connection between the frame and the slide attachment rail, such as seen at FIGS. 7E and 7F). The vertical wall 302 can extend generally vertically from, or perpendicular relative to, the base 303, and, in some cases, with such an orientation of the vertical wall 302, the base 303 can extend out from the vertical wall 302 along an axis that is parallel to an axis along which the photovoltaic receptacle 313 extends out from the vertical wall 302. The embodiment of the lateral frame portion 301 at FIG. 3A has the base 303 so extending out from the vertical wall 302 in a first direction that is opposite a second direction at which the photovoltaic receptacle 313 extends out from the vertical wall 302. Thus, the lateral frame portion 301 at FIG. 3A can have the base 303 and the photovoltaic receptacle 313 extending out from the vertical wall 302 in different (e.g., opposite) directions.

FIG. 3B shows another embodiment of a lateral frame portion indicated here as lateral frame portion 331. As with the lateral frame portion embodiment 301, the lateral frame portion 331 can likewise include the photovoltaic receptacle 313, vertical wall 302, and base 303. The lateral frame portion 331 embodiment here can be similar to, or the same as, the lateral frame portion 301 embodiment described in reference to FIG. 3A except that the base 303 can have a different orientation. For example, as shown at FIG. 3B, the lateral frame portion 331 can have the base 303 extending out from the vertical wall 302 in a same direction as the direction at which the photovoltaic receptacle 313 extends out from the vertical wall 302. Thus, for the lateral frame portion 331 embodiment, the base 303 can extend out from the vertical wall 302 along an axis that is parallel to an axis along which the photovoltaic receptacle 313 extends out in the same direction from the vertical wall 302.

FIG. 3C shows another embodiment of a lateral frame portion indicated here as lateral frame portion 361. As with the lateral frame portion embodiment 301, the lateral frame portion 361 can likewise include the photovoltaic receptacle 313 and base 303. However, different here, the lateral frame portion 361 includes skewed wall 362. Photovoltaic receptacle 313 can be at one end portion of the skewed wall 362 and the base 303 can be at another, opposite end portion of the skewed wall 362. The skewed wall 362 can include one or more connecting tabs 315 that can be configured to form a connection with an adjacent component, for instance configured to engage with a complementary connection aperture (e.g., connection aperture 305 of a longitudinal frame portion 102) to form a connection joint between adjacent frame portions (e.g., to form a connection joint between a lateral frame portion 101 and a longitudinal frame portion 102, such as seen at FIGS. 5B and 9A) and/or to receive a complementary connection aperture of a slide attachment rail (e.g., to form a connection between the frame and the slide attachment rail, such as seen at FIGS. 7E and 7F). The skewed wall 362 can extend from the base 303 at a skewed angle ranging from one to eighty five degrees, such as ranging from ten to seventy five degrees, ranging from twenty to seventy degrees, or ranging from thirty to sixty degrees. The base 303 can extend out from the skewed wall 362 along an axis that is parallel to an axis along which the photovoltaic receptacle 313 extends out from the skewed wall 362. The embodiment of the lateral frame portion 361 at FIG. 3C has the base 303 so extending out from the skewed wall 362 in a same direction as a direction at which the photovoltaic receptacle 313 extends out from the skewed wall 362.

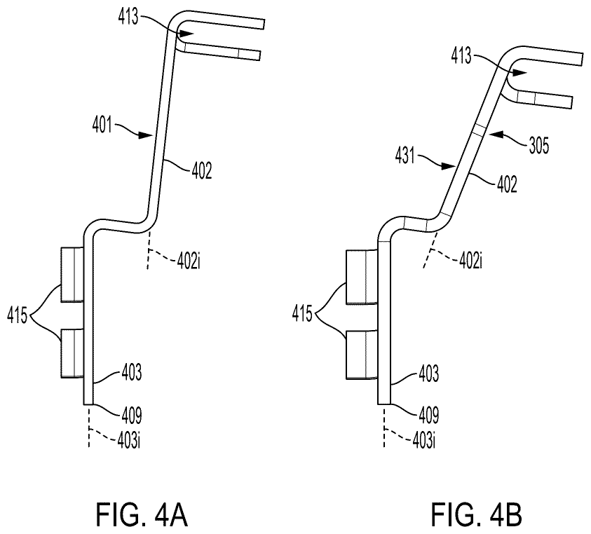

FIGS. 4A-4B illustrate embodiments of a longitudinal frame portion 102 of the solar module frame assembly 100. FIG. 4A is an elevational view of one embodiment of such longitudinal frame portion indicated here as 401. And FIG. 4B is an elevational view of another embodiment of such longitudinal frame portion indicated here as 431. For example, one or both of pair of longitudinal frame portions 102A, 102B of the frame assembly 100 can be the longitudinal frame portion 401 or the longitudinal frame portion 431.

Referring to FIG. 4A, the embodiment of the longitudinal frame portion 401 can include photovoltaic receptacle 413, intermediate wall 402, and lower wall portion 403. Photovoltaic receptacle 413 can be configured to receive photovoltaic cells 99, such as configured to receive a photovoltaic laminate therein. Photovoltaic receptacle 413 can be at one end portion of the intermediate wall 402 and the lower wall portion 403 can be at another, opposite end portion of the intermediate wall 402. The lower wall portion 403 can include one or more connecting tabs 415 that can be configured to form a connection with an adjacent component, for instance configured to engage with a complementary connection aperture (e.g., of a lateral frame portion 101) to form a connection joint between adjacent frame portions (e.g., to form a connection joint between a lateral frame portion 101 and a longitudinal frame portion 102, such as seen at FIGS. 5B and 9A) and/or to engage with a complementary connection aperture of a slide attachment rail (e.g., to form a connection between the frame and the slide attachment rail, such as seen at FIGS. 7E and 7F). The intermediate wall 402 can extend along an intermediate wall axis 402i. As shown here, the intermediate wall 402 can be generally vertical with the intermediate wall axis 402i generally perpendicular relative to the photovoltaic receptacle 413. The lower wall portion 403 can extend along a lower wall axis 403i. As shown here, the lower wall portion 403 can be generally skewed relative to the photovoltaic receptacle 413 with the lower wall axis 403i skewed relative to the photovoltaic receptacle 413. The lower wall portion 403 can also be skewed relative to the intermediate wall 402 such that the intermediate wall axis 402i and the lower wall axis 403i intersect. In particular, as is shown here, the lower wall portion 403 can be skewed relative to the intermediate wall 402 in a direction with the lower wall portion 403 pointing toward the photovoltaic receptacle 413 such that the lower wall axis 403i extending from a free-floating distal end portion 409 of the lower wall portion 403 intersects a plane within which the photovoltaic receptacle 413 sits. For instance, a pair of longitudinal frame portions 401 and a pair of lateral frame portion 301 or 331 can be used together to form frame 103.

Referring to FIG. 4B, as with the longitudinal frame portion embodiment 401, the embodiment of the longitudinal frame portion 431 can include photovoltaic receptacle 413, intermediate wall 402, and lower wall portion 403. The longitudinal frame portion 431 embodiment here can be similar to, or the same as, the longitudinal frame portion 401 embodiment described in reference to FIG. 4A except that the intermediate wall 402 can have a different orientation. For example, as shown at FIG. 4B, the longitudinal frame portion 431 can have the intermediate wall 402 skewed between the photovoltaic receptacle 413 and the lower wall portion 403 instead of vertical as with the embodiment at FIG. 4A. More specifically, as shown at FIG. 4B, the intermediate wall 402 can extend along axis 402i from photovoltaic receptacle 413 at a skewed angle ranging from one to eighty five degrees, such as ranging from ten to seventy five degrees, ranging from twenty to seventy degrees, or ranging from thirty to sixty degrees. The lower wall portion 403 can extend along axis 403i also at a skewed angle relative to photovoltaic receptacle 413. For instance, as shown here, lower wall portion 403 can extend along axis 403i at a skewed angle relative to photovoltaic receptacle 413 in a first direction while intermediate wall 402 can extend along axis 402i at a skewed angle relative to photovoltaic receptacle 413 in a second direction different than (e.g., opposite as shown here at FIG. 4B) the first direction of the lower wall portion 403. Thus, the intermediate wall axis 402i and the lower wall axis 403i can intersect, such as at an intersection point on the lower wall portion 403. In particular, as is shown here, the lower wall portion 403 can be skewed relative to the intermediate wall 402 in a direction with the lower wall portion 403 pointing toward the photovoltaic receptacle 413 such that the lower wall axis 403i extending from a free-floating distal end portion 409 of the lower wall portion 403 intersects a plane within which the photovoltaic receptacle 413 sits. For instance, a pair of longitudinal frame portions 431 and a pair of lateral frame portions 361 can be used together to form frame 103.

FIGS. 5A-5B illustrate one example for assembling together pairs of longitudinal frame portions 102 and pairs of lateral frame portions 101 to form the solar module frame assembly 100.

FIG. 5A is an exploded, perspective view of the solar module frame assembly 100. As seen here, a pair of lateral frame portions 101A, 101B and a pair of longitudinal frame portions 102A, 102B can be assembled together to form frame assembly 100. In particular, one end of longitudinal frame portion 102A can be joined to one end of lateral frame portion 101A and an opposite end of longitudinal frame portion 102A can be joined to one end of lateral frame portion 101B. Likewise, one end of longitudinal frame portion 102B can be joined to one end of lateral frame portion 101A and an opposite end of longitudinal frame portion 102B can be joined to one end of lateral frame portion 101B. Various mechanisms can be used to join such frame portions to form frame assembly.

As one example shown at FIG. 5B, longitudinal frame portion 102A can be joined to lateral frame portion 101A at a connection joint 501 between end portions of longitudinal frame portion 102A and lateral frame portion 101A. The illustrated embodiment uses one or more folded material portions of the frame portion 102A and/or 101A to join the adjacent longitudinal and lateral frame portions 102A, 101A. As shown here at the example of FIG. 5B, the longitudinal frame portion 102A includes connecting tabs 415 and the lateral frame portion 101A includes connection apertures 305. To join the longitudinal and lateral frame portions 102A, 101A in this example, the connecting tabs 415 at the longitudinal frame portion 102A can initially extend out in a first orientation (e.g., vertically) from the longitudinal frame portion 102A (e.g., vertically from the lower wall portion 403 as shown at FIGS. 4A and 4B) to facilitate insertion of the connecting tabs 415 into one or more of the connection apertures 305 at the lateral frame portion 101A. Then, once the connecting tabs 415 have been inserted into the one or more connection apertures 305 at the lateral frame portion 101A in the first orientation, the connecting tabs 415 can be deformed to a second, different orientation to secure the longitudinal frame portion 102A to the lateral frame portion 101A. For example, as shown at FIG. 4B, once the connecting tabs 415 have been inserted into the one or more connection apertures 305 at the lateral frame portion 101A in the first orientation, the connecting tabs 415 can be deformed to a second orientation, which is different than the first orientation, to secure the longitudinal frame portion 102A to the lateral frame portion 101A. For the illustrated embodiment, the second orientation to which the connecting tabs 415 are deformed is a generally horizontal orientation about ninety degrees offset from the first, vertical orientation. The second orientation to which the connecting tabs 415 are deformed to secure the longitudinal frame portion 102A to the lateral frame portion 101A can act to apply a counterforce from the connecting tabs 415 onto the wall 302 or 362 of the lateral frame portion 101A.

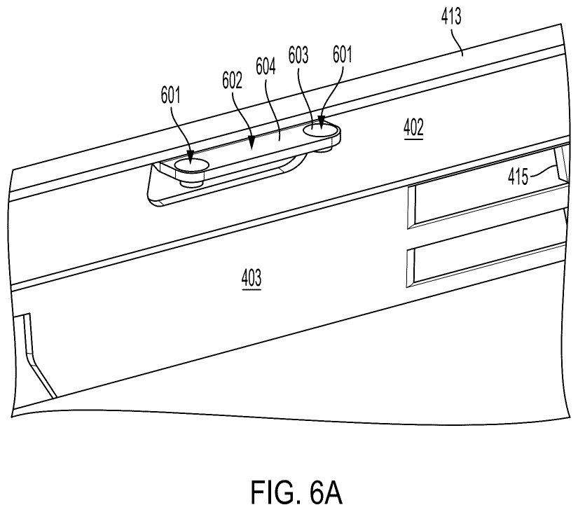

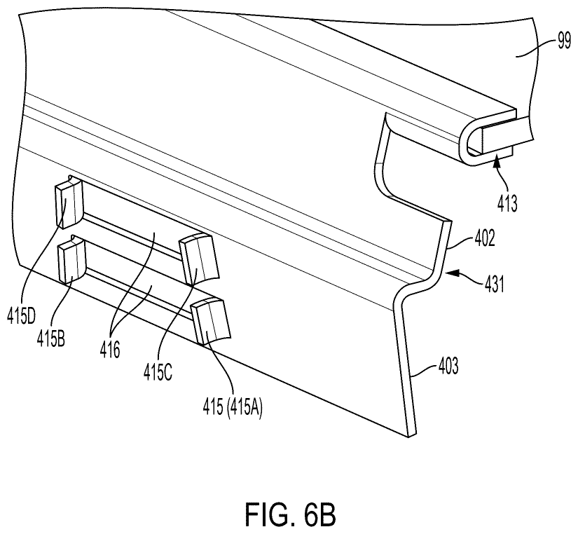

FIGS. 6A-6B illustrate further embodiments of a longitudinal frame portion 102 and/or lateral frame portion 101 with one or more additional features.

FIG. 6A is a perspective view of a portion of longitudinal frame portion 102 having one or more force dampening pins 601 at a force dampening flange 602 of the longitudinal frame portion 102. While FIG. 6A shows the example of the force dampening pin(s) 601 and the force dampening flange 602 at the longitudinal frame portion 102, the force dampening pin(s) 601 and the force dampening flange 602 can be included at the lateral frame portion 101 similarly in addition to or as an alternative to inclusion at the longitudinal frame portion 102 ad shown at FIG. 6A.

The one or more force dampening pins 601 can be configured to absorb, and thus dampen, one or more forces imparted between the frame portion (e.g., longitudinal frame portion 102) and another solar tracker component, such as the torque tube. As one such example, the one or more force dampening pins 601 can be configured to absorb vibrational forces imparted between the frame assembly 100 (e.g., from the longitudinal frame portion 102) and the rail which couples the frame assembly 100 to the torque tube. To receive and support the one or more force dampening pins 601, the frame portion 102 can include the force dampening flange 602. The force dampening flange 602 can extend out from the frame portion 102 in a direction opposite the outward extension of the one or more connecting tabs 415 and in a same direction as the photovoltaic receptacle 413 such that the force dampening flange 602 can be positioned underneath the photovoltaic cells 99. A top end 603 of the one or more force dampening pins 601 can be extend out beyond an uppermost surface 604 of the force dampening flange 602 such that at a portion of the force dampening pins 601 is above the force dampening flange 602 closer to the photovoltaic cells 99. As such, the force dampening pins 601 can serve as a contact point at the frame portion 102 for transferring force (e.g., vibrational force) during solar tracker operation.

FIG. 6B is a perspective view of a portion of a longitudinal frame portion and/or lateral frame portion having one or more connecting tabs 415 for coupling the frame portion to a support structure, such as a rail (e.g., slide attachment rail). The illustrated embodiment here shows the example of longitudinal frame portion 431 having the connecting tabs 415, though other frame portion embodiments disclosed herein can have the same or similar features relating to the connecting tabs 415 and other features disclosed with respect to FIG. 6B.

The longitudinal frame portion 431 example shown here includes a plurality of connecting tabs 415. In particular, the illustrated longitudinal frame portion 431 has two sets of connecting tabs 415-a first set of connecting tabs 415 that includes first connecting tab 415A and second connecting tab 415B and a second set of connecting tabs 415 that includes third connecting tab 415C and fourth connecting tab 415D. The first set of connecting tabs 415A, 415B are axially aligned along a longitudinal length of the frame portion 431, and the second set of connecting tabs 415C, 415D are also axially aligned along a longitudinal length of the frame portion 431 but at a location spaced apart along the lower wall portion 403 from the first set of connecting tabs 415A, 415B. As one example, connecting tabs 415 can be formed as material folds of the frame portion 431. For instance, cuts can be made to the lower wall portion 403 to define sides of each connecting tab 415, and then each connecting tab 415 can be folded using the cuts to create folded material connecting tabs 415 that extend out, in a direction away from the photovoltaic receptacle 413, from the lower wall portion 403. The pairs of folded material connecting tabs 415 can leave an open slot 416 at lower wall portion 403 where the connecting tabs 415 are folded away from and out from the lower wall portion 403. The connecting tabs 415 can be configured, for instance, to engage with one or more connection apertures at a rail (e.g., slide attachment rail) (e.g., as shown at FIGS. 7D-7F) or to engage with to join to an adjacent frame portion (e.g., as shown at FIG. 5B).

FIGS. 7A-7F illustrate coupling solar module frame assemblies, such as a plurality of solar module frame assemblies 100, to a slide attachment rail 704 at torque tube 14 of a solar tracker. Coupling the solar module frame assemblies 100 to the slide attachment rails 704 at the torque tube 14 can act to couple the solar module frame assemblies 100 to the torque tube 14.

FIG. 7A is a perspective view showing an embodiment of slide attachment rails 704 at the torque tube 14 and exploded, plurality of solar module frame assemblies 100A, 100B, 100C to be coupled to the slide attachment rails 704 at the torque tube 14. The plurality of solar module frame assemblies 100 can be moved in direction 701 toward slide attachment rails 704 to bring the plurality of solar module frame assemblies 100A, 100B, 100C into contact with respective slide attachment rails 704. For example, moving the plurality of solar module frame assemblies 100A, 100B, 100C into contact with respective slide attachment rails 704 can cause the plurality of solar module frame assemblies 100A, 100B, 100C to couple to respective slide attachment rails 704 as a result of this relative movement. In some such examples, the plurality of solar module frame assemblies 100A, 100B, 100C can be moved relative to the respective slide attachment rails 704 to cause the plurality of solar module frame assemblies 100A, 100B, 100C to couple to respective slide attachment rails 704 as a result of this relative movement without using any additional, separate component fastening mechanism at the contact interface between a given frame portion (e.g., lower wall portion 403) of a given solar module frame assembly 100 and a given slide attachment rail 704. This can be useful in increasing the cost efficiency associated with installing a solar tracker on site.

FIG. 7B shows a first elevational view of a pair of solar module frame assemblies 100A, 100B exploded relative to one slide attachment rail 704 at torque tube 14, and FIG. 7C shows the same but at a second side elevational view rotated ninety degrees from the first side elevational view of FIG. 7B (such that in FIG. 7C only one solar module frame assembly 100A of the pair is seen at FIG. 7C). For example, one slide attachment rail 704 can be configured to receive and couple to both of the pair of solar module frame assemblies 100A, 100B as the solar module frame assemblies 100A, 100B are moved relative to, and brought into contact with, the slide attachment rail 704. To do so, for instance, the connecting tabs 415 at the frame portion 102 can be axially aligned, in direction 701, with first and second connector sidewalls 707, 708 at each side of the slide attachment rail 704 and the slots 416 at the frame portion 102 can be axially aligned, in direction 701, with complementary connecting tabs 716 at slide attachment rail.

Each slide attachment rail 704 can include one or more frame connectors 703. As shown here, each slide attachment rail 704 can include a first frame connector 703A and a second frame connector 703B. First and second frame connectors 703A, 703B can be spaced apart from one another along a body of the slide attachment rail 704, for instance, a distance 709 corresponding to the spacing between the sets of the pairs of connecting tabs 415 as shown at FIG. 7C. Each of the one or more frame connectors 703A, 703B at the slide attachment rail 704 can include a base 710, a first side 705 extending up from the base 710, and a second side 706 extending up from the base 710 at a side of base 710 opposite the first side 705.

The first side 705 can be configured to receive and couple to solar module frame assembly 100A when solar module frame assembly 100A is moved, in direction 701, into contact with first side 705 at connector 703, and the second side 706 can be configured to receive and couple to solar module frame assembly 100B when solar module frame assembly 100B is moved, in direction 701, into contact with second side 706 at connector 703. First side 705 of connector 703 can have first connector sidewall 707, and second side 706 of slide attachment rail 704 can have second connector sidewall 708. As shown for the illustrated embodiment, each of the first connector sidewall 707 and the second connector sidewall 708 can be skewed relative to base 710 of connector 703. For instance, first connector sidewall 707 can extend from base 710 at a skewed angle that corresponds (e.g., is equal) to a skewed angle of lower wall portion 403 of the longitudinal frame portion 102B, and second connector sidewall 708 can extend from base 710 at a skewed angle that corresponds (e.g., is equal) to a skewed angle of lower wall portion 403 of the longitudinal frame portion 102A. Thus, as lower wall potion 403 of longitudinal frame portion 102B is brought into contact with first connector sidewall 707, the complementary, corresponding skewed angles at the lower wall portion 403 of the longitudinal frame portion 102B and at the first connector sidewall 707 can allow the lower wall portion 403 to move (e.g., slide) along the first connector sidewall 707. Likewise, as lower wall potion 403 of longitudinal frame portion 102A is brought into contact with second connector sidewall 708, the complementary, corresponding skewed angles at the lower wall portion 403 of the longitudinal frame portion 102A and at the second connector sidewall 708 can allow the lower wall portion 403 to move (e.g., slide) along the second connector sidewall 708.

Moving the respective frame portions 102A, 102B into contact with the slide attachment rail 704 can cause each frame portion 102A, 102B to engage with and couple to the slide attachment rail 704 (e.g., without a separate fastening component, as noted previously). FIGS. 7D-7F show the plurality of solar module frame assemblies 100A, 100B, 100C coupled to the slide attachment rails 704 at the torque tube 14, with FIG. 7D showing a perspective view of the plurality of solar module frame assemblies of 100A-100C coupled to the slide attachment rails 704, FIG. 7E showing the first elevational view of FIG. 7B but with the pair of solar module frame assemblies 100A, 100B now coupled to common slide attachment rail 704, and FIG. 7F showing the second side elevational view of FIG. 7C but with the solar module frame assemblies 100A, 100B now coupled to the slide attachment rail.

As seen best at FIGS. 7E and 7F, when lower wall portion 403 of second longitudinal frame portion 102B is moved into contact with (e.g., slid along) first connector sidewall 707 at connector 703A of slide attachment rail 704 in direction 701, connecting tabs 716 (e.g., teeth) at first connector sidewall 707 are brought into engagement with slots 416 at lower wall portion 403 of second longitudinal frame portion 102B. Also, as best seen at FIG. 7F, when lower wall portion 403 of second longitudinal frame portion 102B is moved into contact with (e.g., slid along) first connector sidewall 707 at connector 703A of slide attachment rail 704 in direction 701, connecting tabs 415 can engage a first end side 707A of the first connector sidewall 707 and can engage a second, opposite end side 707B of first connector sidewall 707. For instance, connecting tabs 415B and 415D can engage or be adjacent to first end side 707A of first connector sidewall 707 at connector 703A while connecting tabs 415A and 415C can engage or be adjacent to second end side 707B of first connector sidewall 707 at connector 703A. Engagement of connecting tabs 716 at first connector sidewall 707 with slots 416 at lower wall portion 403 of second longitudinal frame portion 102B can help to retain the frame 100A in one direction at torque tube 14 while engagement of connecting tabs 415 at opposite end sides 707A, 707B of the connector's first connector sidewall 707 can help to retain the frame 100A in another, different direction.

Likewise, when lower wall portion 403 of first longitudinal frame portion 102A is moved into contact with (e.g., slid along) second connector sidewall 708 at connector 703A of slide attachment rail 704 in direction 701, connecting tabs 716 (e.g., teeth) at second connector sidewall 708 are brought into engagement with slots 416 at lower wall portion 403 of first longitudinal frame portion 102A. Also, when lower wall portion 403 of first longitudinal frame portion 102A is moved into contact with (e.g., slid along) second connector sidewall 708 at connector 703A of slide attachment rail 704 in direction 701, connecting tabs 415 can engage first end side 707A of the second connector sidewall 708 and can engage a second, opposite end side (not seen) of second connector sidewall 708. For instance, connecting tabs 415B and 415D can engage or be adjacent to the first end side of the second connector sidewall 708 at connector 703A while connecting tabs 415A and 415C can engage or be adjacent to the second end side of second connector sidewall 708 at connector 703A. Engagement of connecting tabs 716 at second connector sidewall 708 with slots 416 at lower wall portion 403 of first longitudinal frame portion 102A can help to retain the frame 100B in one direction at torque tube 14 while engagement of connecting tabs 415 at opposite end sides of the connector's second connector sidewall 708 can help to retain the frame 100B in another, different direction.

Such coupling and securement of a pair of solar module frames 100A, 100B can be useful in reducing or eliminating dedicated, additional fastening components or connections between the connector(s) 703 at the slide attachment rail 704 and the interfacing longitudinal frame portions 102A, 102B.

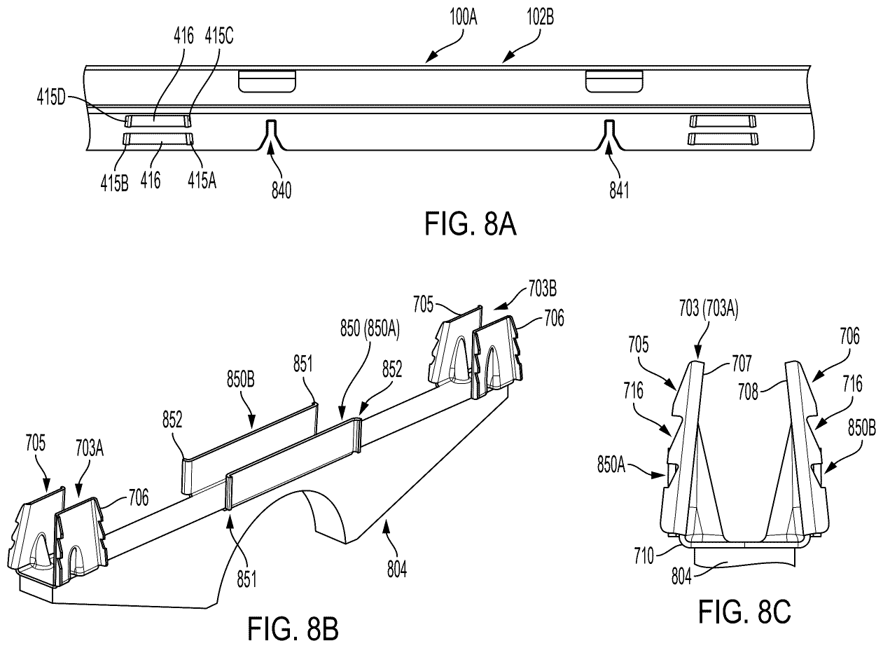

FIGS. 8A-8C illustrate one embodiment of coupling slide assembly orientation features that can be included at one or more frame portions of the solar module frame assembly and/or the slide attachment rail disclosed elsewhere herein. FIG. 8A is an elevational view of longitudinal frame portion 102B having rail slide flange orientation receptacles 840, 841. FIGS. 8B and 8C show, respectively, a perspective view and an elevational view of slide attachment rail 804 with rail slide flanges 850 (e.g., first side rail slide flange 850A and second side rail slide flange 850B).

The rail slide flange orientation receptacles 840, 841 of one frame portion 102B can be configured to engage with first side rail slide flange 850A while another, different frame portion (e.g., longitudinal frame portion 102A of another frame assembly) can be configured to engage with second side rail slide flange 850B. Thus, slide attachment rail 804 can be configured to: (i) engage one longitudinal frame portion 102B of one frame assembly at each of first side rail slide flange 850A, second side 706 of first frame connector 703A, and second side 706 of second frame connector 703B, and (ii) engage another longitudinal frame portion (e.g., longitudinal frame portion 102A) of another, different frame assembly at each of second side rail slide flange 850B, first side 705 of first frame connector 703A, and first side 707 of second frame connector 703B. Engagement of the frame portions at the respective rail slide flanges 850 can help to assist with centering the frame assemblies along a length of the slide attachment rail 804 and/or to reduce or prevent instances of incorrect assembly of frame portions to create the frame assembly by providing a relative assembly indication via the presence of the rail slide flange orientation receptacles 840, 841 at frame portion(s).

To configure engagement of the frame portion 102A with a given rail slide flange 850 at the slide attachment rail 804, the frame portion 102A can include the rail slide flange orientation receptacles 840, 841 and the given rail slide flange 850 can include corresponding, complementary flange connecting members 851, 852. The flange connecting members 851, 852 can, for some embodiments, be located at opposite sides of the rail slide flange 850. The flange connecting members 851, 852 can project outward from a base of the rail slide flange 850 in a same direction that the connecting tabs 716 project outward from the base 710 of the corresponding side 705 or 706 of the first and second frame connectors 703A, 703B. As one such example illustrated here and referring to the rail slide flange 850A, the flange connecting members 851, 852 can project outward from a base of the rail slide flange 850A in a same direction that the connecting tabs 716 project outward from the base 710 of the side 706 of the first and second frame connectors 703A, 703B.

As shown for the illustrated embodiment, the frame portion 102A can include the rail slide flange orientation receptacles 840, 841 spaced apart along a length of the fame portion 102A a given distance. To facilitate engagement of the rail slide flange orientation receptacles 840, 841 at the corresponding, complementary flange connecting members 851, 852, the flange connecting members 851, 852 can be spaced apart from one another along a length of the slide attachment rail 804 a same distance as the spacing between the rail slide flange orientation receptacles 840, 841. As examples, this spacing between the flange connecting members 851, 852 and equal spacing between the flange orientation receptacles 840, 841 can be 240 mm, 200 mm, or 160 mm.

FIGS. 9A-9B illustrate frame portion features for stacking a plurality of solar module frame assemblies 100A, 100B, 100C, 100D, such as for transport. FIG. 9A is an exploded, perspective view showing a stacking axis 901 between two solar module frame assemblies 100B, 100C. FIG. 9B is an elevational view of the stack of a plurlaity of solar module frame assemblies 100A, 100B, 100C, 100D. Two solar module frame assemblies, such as 100B and 100C as shown at FIG. 9A, can be stacked together along stacking axis 901 and this stacking along axis 901 can be repeated for each subsequent frame assembly (e.g., frame assembly 100A) to be stacked.

When frame assemblies 100A, 100B, 100C, 100D are stacked, each such stacked frame assemblies 100A, 100B, 100C, 100D can engage with at least one adjacent frame assembly. For example, as shown for the illustrated embodiment, each frame assembly 100A-100D can include a stacking flange 902 and a stacking flange receptacle 903. As seen at the example at FIG. 9B, the stacking flange 902 of one frame assembly 100A can be received at the stacking flange receptacle 903 of an adjacent, lower frame assembly 100B in the stack. When the stacking flange 902 is received at the stacking flange receptacle 903, the stacked, adjacent frame assemblies 100A, 100B can be retained together in the stack. As this stacking flange 902-to-stacking flange receptacle 903 engagement is made sequentially for each additional frame assembly added to the stack, the stack of frame assemblies can be retained together in a stack that efficiently utilizes space for cost-effective transport of a stack of frame assemblies 100.

As shown for the illustrated embodiment, the stacking flange 902 can be located at the lower wall portion 403 of longitudinal frame portion 102 and the stacking flange receptacle 903 can be located at a plateaued transition between the lower wall portion 403 and the intermediate wall 402 of longitudinal frame portion 102. As such, the stacking flange 903 can project through the generally flat, plateaued transition between the lower wall portion 403 and the intermediate wall 402 of longitudinal frame portion 102 at the location of the stacking flange receptacle 903.

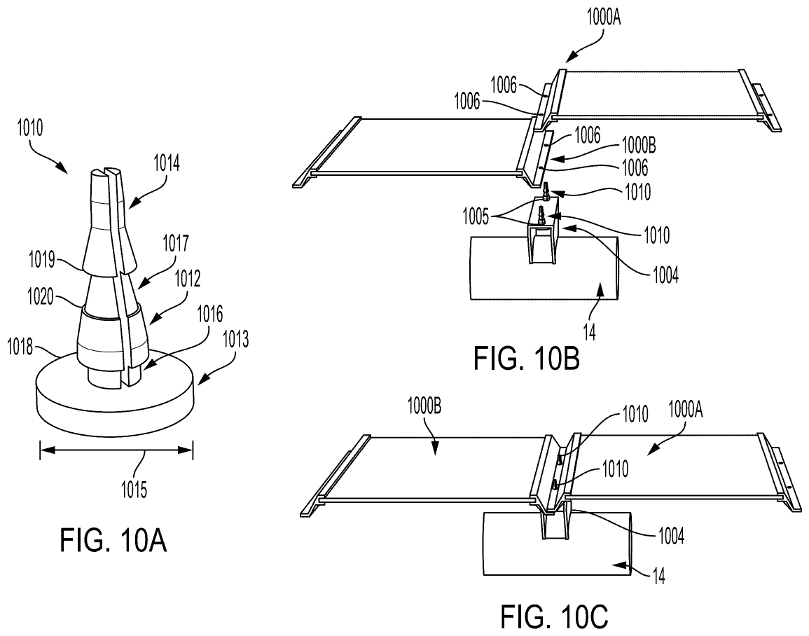

FIGS. 10A-10C illustrate an embodiment of a solar module pin coupler 1010 that can be configured to couple one or more solar module frame assemblies to torque tube 14. The illustrated example shows a pair of solar module pin couplers 1010 used to secure a pair of solar module frame assemblies 1000A, 1000B to torque tube 14.

FIG. 10A is a perspective view of the solar module pin coupler 1010. The solar module pin coupler 1010 can include pin body 1012. Pin body 1012 can include pin base 1013 and pin shaft 1014. Width 1015 of pin base 1013 can be greater than a width of pin shaft 1014. Pin shaft 1014 can extend out from pin base 1003. Pin shaft 1014 can include rail engagement region 1016 along one portion of the length of the pin shaft 1014 extending out from pin base 1003 and can include frame engagement region 1017 along another, different portion of the length of the pin shaft 1004.

As shown for the illustrated embodiment, the pin body 1012 can include a split extending along some or all of the length of the pin body 1012. For example, the split can extend along some or all of a length of the pin shaft 1014 and define a cutout space generally bisecting the pin shaft 1014 along some or all of the length of the pin shaft 1014. The split at the pin shaft 1014 can impart resilience to the pin body 1012 at the pin shaft 1014 such that when a force is applied to the pin shaft 1014, the split can enable the pin shaft 1014 to compress together to reduce a width of the pin shaft 1014. For instance, the pin shaft 1014 can define a first width in direction 1015, but when a force is applied at the pin shaft 1014 the pin shaft 1014 can compress together at the split to define a second width in the direction 1015 that is less than the first width prior to application of the compressive force at the pin shaft 1014. This resilient compressibility of the pin shaft 1014 can enable the pin shaft 1014 to receive component(s) (e.g., rail and solar module(s)) at the pin shaft 1014 when the pin shaft is compressed to the second, smaller width and then enable the pin shaft 1014 to revert back to its original first, larger width when the component(s) are received at a desired portion along the pin shaft 1014 and the compressive force is removed. Thus, when a compressive force is applied at the pin shaft 1014, the pin shaft 1014 can be configured to move from a biased coupling configuration to a compressed installation configuration that reduces the width of the pin shaft 1014. When the pin shaft 1014 is moved to the compressed installation configuration, the pin coupler 1010 can be configured to couple the solar module to the rail by receiving the rail pin aperture at the rail engagement region and by receiving the frame pin aperture at the frame engagement region. Yet, when the pin shaft 1014 is at the biased coupling configuration, the pin coupler 1010 can be configured to prevent reception of the rail pin aperture at the rail engagement region and the frame pin aperture at the frame engagement region.

The pin coupler 1010 can be configured to engage with rail 1004 at the rail engagement region 1016, and the pin coupler 1010 can be configured to engage with each of the pair of frame assemblies 1000A, 1000B at the frame engagement region 1017. More specifically, as to engagement with rail 1004, as shown for the illustrated embodiment, the rail engagement region 1016 can be defined at the pin body 1012 as an indented or recessed region along a portion of the length of the pin body 1012 bounded by protruded shoulder 1018 and pin base 1013. Protruded shoulder 1018 and pin base 1013 can each have greater widths 1015 than width 1015 of rail engagement region 1016 such that rail engagement region 1016 is recessed relative to the adjacent protruded shoulder 1018 and adjacent pin base 1013. This recessed configuration of the rail engagement region 1016 can help to configure the pin coupler 1010 to engage rail 1004. As to engagement with the pair of frame assemblies 1000A, 1000B, as shown for the illustrated embodiment, the frame engagement region 1017 can be defined at the pin body 1012 as an indented region along a portion of the length of the pin body 1012 bounded by protruded shoulder 1019 at one side and bounded by protruded shoulder 1020 at another, opposite side. Protruded shoulders 1019 and 1020 can each have greater widths 1015 than width 1015 of frame engagement region 1017 such that frame engagement region 1017 is recessed relative to each of the adjacent protruded shoulders 1019, 1020. This recessed configuration of the frame engagement region 1017 can help to configure the pin coupler 1010 to engage each of the pair of frame assemblies 1000A, 1000B.

FIG. 10B shows an exploded, perspective view of a pair of solar module frame assemblies 1000A, 1000B along an exploded, coupling axis of assembly. As seen at FIG. 10B, before coupling the frame assemblies 1000A, 1000B to the rail 1004, one pin coupler 1010 can be placed within one rail pin aperture 1005 at rail 1004 and another pin coupler 1010 can be placed within another rail pin aperture 1005 at rail 1004. When a given pin coupler 1010 is so placed at a given rail pin aperture 1005, such as at FIG. 10B, the pin base 1013 can be at one side of rail pin aperture 1005 and the protruded shoulder 1018 can be at another, opposite side of the same rail pin aperture 1005 with the rail engagement region 1016 at the rail pin aperture 1005.

FIG. 10C shows the corresponding assembled view along the coupling axis with the pair of frame assemblies 1000A, 1000B coupled to the rail 1004 via a pair of solar module pin couplers 1010. As seen at FIG. 10C, to then couple the pair of frame assemblies 1000A, 1000B to the rail 1004 using the pair of pin couplers 1010, solar module frame assemblies 1000A, 1000B can be moved into contact with the pair of pin couplers 1010 already placed at rail 1004. As frame assembly 1000B is first brought into contact with the pair of pin couplers 1010, the frame assembly 1000B can be moved along each of the pair of pin couplers 1010 until the frame pin apertures 1006 are at the frame engagement region 1017 of the respective interfacing pin coupler 1010. This can include each respective frame pin aperture 1006 of the pair at the frame assembly 1000B being at the frame engagement region 1017, the protruded shoulder 1019 being at one side of frame pin aperture 1006, and the protruded shoulder 1020 being at another, opposite side of the frame pin aperture 1006. Then, as also seen at FIG. 10C, as frame assembly 1000A is next brought into contact with the pair of pin couplers 1010, the frame assembly 1000A can be moved along each of the pair of pin couplers 1010 until the frame pin apertures 1006 of the assembly 1000A are at the frame engagement region 1017 of the respective interfacing pin coupler 1010. This can include each respective frame pin aperture 1006 of the pair at the frame assembly 1000A being at the frame engagement region 1017, the protruded shoulder 1019 being at one side of frame pin aperture 1006, and the protruded shoulder 1020 being at another, opposite side of the frame pin aperture 1006. Thus, each of the pair of frame assemblies can be retained at pin coupler 1010 at the frame engagement region 1017. And the geometric configuration of the pin coupler 1010 relative to the frame engagement region 1017 and protruded shoulders 1019, 1020 can help to retain the pair of frame assemblies 1000A, 1000B at the pin coupler 1010 without necessitating dedicated fastening component connections in addition to the connection at the pin coupler 1010 as a result of relative movement between the frame assemblies 1000A, 1000B at the pin coupler 1010.

Various examples have been described. These and other examples are within the scope of this disclosure and claims pursed from this disclosure.

What is claimed is:

1. A solar module coupling assembly comprising:
a pin coupler comprising a pin body, the pin body comprising a pin base and a pin shaft that extends out from the pin base, the pin base comprising a width that is greater than a width of the pin shaft, the pin shaft comprising a rail engagement region along one portion of a length of the pin shaft and a frame engagement region along another, different portion of the length of the pin shaft;
a rail comprising a rail pin aperture; and
a solar module comprising a frame pin aperture,
wherein the pin coupler is configured to couple the solar module to the rail by receiving the rail pin aperture at the rail engagement region and by receiving the frame pin aperture at the frame engagement region.

2. The assembly of claim 1, wherein the rail engagement region defines a first recessed region along the length of the pin shaft, wherein the frame engagement region defines a second recessed region along the length of the pin shaft, and wherein the first recessed region is closer to the base than the second recessed region.

3. The assembly of claim 2, wherein the first recessed region is bounded at one side by the pin base and bounded at another, opposite side by a first protruded shoulder.

4. The assembly of claim 3, wherein the second recessed region is bounded at one side by a second protruded shoulder and bounded at another, opposite side by a third protruded shoulder.

5. The assembly of claim 4, wherein the pin body comprises a split extending along at least some of the length of the pin shaft.

6. The assembly of claim 5, wherein the split extends along at least some of the length of the pin shaft from an end of the pin shaft opposite the pin base.

7. The assembly of claim 5, wherein the pin shaft is configured to flex inward about the split to reduce the width of the pin shaft.

8. The assembly of claim 7, wherein, when a compressive force is applied at the pin shaft, the pin shaft is movable from a biased coupling configuration to a compressed installation configuration that reduces the width of the pin shaft.

9. The assembly of claim 8, wherein the pin coupler is configured to couple the solar module to the rail by receiving the rail pin aperture at the rail engagement region and by receiving the frame pin aperture at the frame engagement region when the pin shaft is moved to the compressed installation configuration.

10. The assembly of claim 9, wherein the pin coupler is configured to prevent reception of the rail pin aperture at the rail engagement region and the frame pin aperture at the frame engagement region when the pin shaft is at the biased coupling configuration.

11. The assembly of claim 4, wherein the rail comprises the first pin aperture at a first side of the rail, and wherein the rail further comprises a semi-circular torque tube interface at a second side of the rail opposite the first side.

12. The assembly of claim 11, wherein the solar module is a first solar module and the frame pin aperture is a first frame pin aperture, and wherein the assembly further comprises:
a second solar module comprising a second frame pin aperture,
wherein the pin coupler is configured to couple the first solar module and the second solar module to the rail by receiving the rail pin aperture at the rail engagement region and by receiving the first frame pin aperture and the second frame pin aperture at the frame engagement region.

13. The assembly of claim 12, wherein the first solar module comprises a first frame side flange and the second solar module comprises a second frame side flange, wherein the first frame pin aperture is defined at the first frame side flange, wherein the second frame pin aperture is defined at the second frame side flange.

14. The assembly of claim 13, wherein the pin coupler is configured to couple the first solar module and the second solar module to the rail by receiving the rail pin aperture at the rail engagement region and stacking the first frame side flange and second frame side flange on top of one another at the frame engagement region.

15. The assembly of claim 14, wherein the frame engagement region extends along a greater length of the pin shaft than the rail engagement region.

16. A solar module pin coupler comprising:
a pin base having a first width;
a pin shaft that extends out from the pin base, the pin shaft having a second width that is less than the first width of the pin base, the pin shaft comprising a rail engagement region along one portion of a length of the pin shaft and a frame engagement region along another, different portion of the length of the pin shaft, wherein the frame engagement region extends along a greater length of the pin shaft than the rail engagement region,
wherein the pin shaft is configured to flex inward to reduce the second width of the pin shaft to receive a rail component and a solar module component at the pin shaft.

17. The pin coupler of claim 16, wherein the rail engagement region defines a first recessed region along the length of the pin shaft, wherein the frame engagement region defines a second recessed region along the length of the pin shaft, wherein the first recessed region is closer to the base than the second recessed region, and wherein the second recessed region extends along a greater length of the pin shaft than the first recessed region.

18. The pin coupler of claim 17, wherein the first recessed region is bounded at one side by the pin base and bounded at another, opposite side by a first protruded shoulder, and wherein the second recessed region is bounded at one side by a second protruded shoulder and bounded at another, opposite side by a third protruded shoulder.

19. The pin coupler of claim 18, wherein the pin is shaft comprises a split extending along at least some of the length of the pin shaft, and wherein the pin shaft is configured to flex inward about the split to reduce the second width of the pin shaft.

20. The pin coupler of claim 19, wherein the split extends along at least some of the length of the pin shaft from an end of the pin shaft opposite the pin base.
